(19) United States
(12) Patent Application Publication
(10) Pub. No.: US 2007/0098875 A1
(43) Pub. Date: May 3, 2007

(54) Potato based food product

(76) Inventors: John G. Howard, KING'S LYNN, NORFOLK (GB); Pamela Hume, Scarborough (GB)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/549,738

(22) PCT Filed: Mar. 17, 2004
(86) PCT No.: PCT/GB04/01136

§ 371 Date: Jul. 11, 2006

(30) Foreign Application Priority Data
Mar. 19, 2003 (GB) 0306317.9

(51) Int. Cl. A23L 1/216

(52) U.S. Cl. 426/637

(57) ABSTRACT

The present invention provides a method of preparing a potato based food product comprising the steps of: processing potatoes into potato articles having a desired size and shape, blanching said potato articles, dipping said blanched potato articles in a solution to prevent non-enzymic oxidation of the potato articles, drying said potato articles, coating said potato articles in an emulsion containing starch, oil, salt and colouring, introducing said coated articles into a hot air environment; and removing said articles from said hot air environment.

The present invention relates to the preparation of a food product and in particular to the preparation of a potato based food product.

One method of preparing par-cooked potato product, such as chips or fries, is to wash, cut and blanch the raw potato, dry the blanched potato pieces by about 10% and par fry the pieces in oil for around 3 minutes a temperature of about 140° C. The chips are subsequently cooled and bagged ready for chilling or freezing. The par-cooked chips or fries are typically fried in oil once again by the end consumer to complete the cooking process. This method permits the rapid preparation of chips or fries by the end user, which fries or chips have an acceptable taste and mouth feel. The oil frying steps results in chips or fries with a relatively high fat content which it would be desirable to reduce.

According to the present invention there is provided a method of preparing a potato based food product, the method comprising the steps of:
processing potatoes into potato articles having a desired size and shape, blanching said potato articles,
dipping said blanched potato articles in a solution to prevent non-enzymic oxidation of the potato articles,
drying said potato articles,
coating said potato articles in an emulsion containing starch, oil, salt and colouring,
introducing said coated articles into a hot air environment; and
removing said articles from said hot air environment.

The step of processing said potatoes typically comprises steam peeling, trimming to remove any defects and cutting to a desired size. Preferably the potatoes are cut into elongate sticks known variously as chips or fries. Chips typically have a substantially square cross-section of between 8 mm to 15 mm In a preferred embodiment the potatoes are cut into a chip size 11.2 mm by 11.2 mm ( 15/32 of an inch by 15/32 of an inch).

The step of blanching the articles preferably comprises immersing the potato articles in a heated water bath for a period of time. The blanching temperature may be in the range of 70° C. to 95° C. The blanching time may be in the range of 5 minutes to 20 minutes. It will be appreciated that the blanching temperature and time will be at least partially dependent on such factors as the potato variety and the size of the potato articles.

The step of dipping said blanched potato articles in a solution to prevent non-enzymic oxidation of the potato articles may comprise immersing the articles in a Sodium Acid Pyrophosphate solution. The solution may comprise 1% Sodium Acid Pyrophosphate. The solution may be at a temperature of 65° C. and the articles may be immersed for a time period of around 60 seconds.

The step of drying the blanched and dipped potato articles may in one embodiment comprise introducing the articles into an elevated temperature environment. In such an embodiment the articles may be introduced into a warm air environment such as a drying oven. The elevated temperature may be in the range of 90° C. to 120° C. The articles may be dried for a time period of around 4 minutes and may during this drying step experience a drying weight loss of around 4.5%.

Alternatively the blanched and dipped potato articles my be allowed to dry at ambient temperature. In such an embodiment the articles may be allowed to dry at ambient temperature for around ten minutes.

The step of coating the articles may be achieved by any suitable means such as, for example, an appropriately configured enrobing device. The starch containing emulsion also includes oil and salt. The emulsion may include more than one kind of starch. The emulsion preferably also includes a colouring. The colouring may preferably include paprika.

In one embodiment the emulsion may comprise a mixture comprising water, oil, starch, colouring, emulsifier, stabilizer and salt. In such an embodiment the oil may be sunflower oil and the starch Hylon V11. The colouring may comprise turmeric and paprika. The emulsifier may comprise Hamultop 391 emulsifier and the stabilizer H0w 1 stabilizer. The emulsion in such an embodiment may comprises the above referenced components in the following proportions:

| | |
|---|---|
| Water | 53.00%-60.00% |
| Sunflower Oil | 24.00%-28.00% |
| Starch (Hylon V11) | 10.00%-12.00% |
| Tumeric | 0.01%-0.10% |
| Liquid Paprika | 0.01%-0.10% |
| Hamultop 391 emulsifier | 0.80%-1.00% |
| H0w 1 stabiliser | 0.10%-0.30% |
| Salt | 4.00%-6.00% |

In an alternative embodiment the emulsion may comprise a mixture comprising water, oil, starch, flour, dextrin, gum, Sodium Bicarbonate, salt, colouring, oil, Sodium Acid Pyrophosphate and dextrose. The starch element may comprise more than one type of starch. In such an embodiment the starch element of the emulsion may comprise a combination of potato starch and maize starch. The gum may comprise a combination of more than one gum. In such an embodiment the gum may comprise a combination of Guar gum and Xantham gum. The colouring may comprise a combination of Tumeric and Paprika. More specifically the emulsion may comprise a combination of modified potato starch, rice flour, potato dextrin, maize starch, xantham gum, sodium bicarbonate, puron AG, salt, turmeric extract powder, paprika oleoresin, vegetable oil, dextrose and guar gum. The emulsion in such an embodiment may comprises the above referenced components in the following proportions:

| | |
|---|---|
| Water | 48.00%-54.00% |
| Sunflower oil | 13.00%-16.00% |
| Modified Potato Starch E1412 | 9.00%-11.00% |
| Rice Flour | 5.00%-7.00% |
| Potato Dextrin | 9.00%-11.00% |
| Maize Starch | 4.00%-6.00% |
| Xantham Gum | 0.01%-0.10% |
| Sodium Bicarbonate | 0.30%-0.40% |
| Puron AG | 0.40%-0.50% |
| Salt | 1.00%-2.00% |
| Tumeric Extract Powder | 0.01%-0.10% |
| Paprika Oleoresin | 0.01%-0.10% |
| Vegetable Oil | 0.01%-0.10% |
| Dextrose | 0.30%-0.40% |
| Guar Gum | 0.01%-0.10% |

The coating of the articles may be quantified with reference to the pick-up percentage by weight of the emulsion by the potato articles. The pick up percentage may be in the range of 5% to 20%. More preferably the pick up percentage may be in the range of 6% to 17%.

The method may optionally include the additional step of drying the potato articles for a second time after they have been coated in the emulsion. This second drying step may comprise introducing the coated articles into a warm air environment. The articles may be dried at a temperature of between 100° C. and 130° C. More preferably the coated articles may be dried at a temperature of between 105° C. and 120° C. In one embodiment the articles may be dried for a period of between 20 to 35 minutes. In an alternative embodiment the articles may be dried for 20 minutes. The second drying step may be quantified with reference to the weight loss of the coated articles during drying thereof. the drying loss by weight may be in the region of 10% to 25% and more preferably in the range of 12% to 20%.

The final step of introducing the coated articles into a hot air environment may comprises introducing the coated articles into an impingement oven. The hot air environment may have a temperature of between 240° C. to 285° C. The coated articles may be kept in the environment for a period of between 3 to 6 minutes. Again this heating step may be quantified with reference to the weight loss of the coated articles. Preferably the articles experience a weight loss of between 20% to 27%.

According to a second aspect of the present invention there is provided a coating for a potato article the coating comprising an emulsion containing oil, starch, salt and colouring.

In one embodiment the emulsion may comprise a mixture comprising water, oil, starch, colouring, emulsifier, stabilizer and salt. In such an embodiment the oil may be sunflower oil and the starch Hylon V11. The colouring may comprise turmeric and paprika. The emulsifier may comprise Hamultop 391 emulsifier and the stabilizer H0w 1 stabilizer. The emulsion in such an embodiment may comprises the above referenced components in the following proportions:

| | |
|---|---|
| Water | 53.00%-60.00% |
| Sunflower Oil | 24.00%-28.00% |
| Starch (Hylon V11) | 10.00%-12.00% |
| Tumeric | 0.01%-0.10% |
| Liquid Paprika | 0.01%-0.10% |
| Hamultop 391 emulsifier | 0.80%-1.00% |
| H0w 1 stabiliser | 0.10%-0.30% |
| Salt | 4.00%-6.00% |

In an alternative embodiment the emulsion may comprise a mixture comprising water, oil, starch, flour, dextrin, gum, Sodium Bicarbonate, salt, colouring, oil, Sodium Acid Pyrophosphate and dextrose. The starch element may comprise more than one type of starch. In such an embodiment the starch element of the emulsion may comprise a combination of potato starch and maize starch. The gum may comprise a combination of more than one gum. In such an embodiment the gum may comprise a combination of Guar gum and Xantham gum. The colouring may comprise a combination of Tumeric and Paprika. More specifically the emulsion may comprise a combination of modified potato starch, rice flour, potato dextrin, maize starch, xantham gum, sodium bicarbonate, puron AG, salt, turmeric extract powder, paprika oleoresin, vegetable oil, dextrose and guar gum. The emulsion in such an embodiment may comprises the above referenced components in the following proportions:

| | |
|---|---|
| Water | 48.00%-54.00% |
| Sunflower oil | 13.00%-16.00% |
| Modified Potato Starch E1412 | 9.00%-11.00% |
| Rice Flour | 5.00%-7.00% |
| Potato Dextrin | 9.00%-11.00% |
| Maize Starch | 4.00%-6.00% |
| Xantham Gum | 0.01%-0.10% |
| Sodium Bicarbonate | 0.30%-0.40% |
| Puron AG | 0.40%-0.50% |
| Salt | 1.00%-2.00% |
| Tumeric Extract Powder | 0.01%-0.10% |
| Paprika Oleoresin | 0.01%-0.10% |
| Vegetable Oil | 0.01%-0.10% |
| Dextrose | 0.30%-0.40% |
| Guar Gum | 0.01%-0.10% |

Embodiments of the present invention will now be described by way of illustrative examples.

### EXAMPLE 1

Maris Piper potatoes are steam peeled, trimmed to remove any defects and cut into a desired chip size. Typical examples being chips having a cross section of 11.2 mm by 11.2 mm ( 15/32 of an inch by 15/32 of an inch).

The chips are then blanched in water at a temperature of around 75° C. for 6 minutes. After blanching the chips are dipped in an aqueous solution containing 1% Puron for 60 seconds at a temperature of around 65° C. Puron is the trade name for Sodium Acid Pyrophosphate and is used to prevent non-enzymic oxidation of the chips.

The dipped chips are then dried in an elevated temperature environment at around 110° C. During this drying step the chips experience a drying loss of around 4.5%, which is to say that the moisture loss during drying of the chips is ascertainable as a 4.5% reduction in pre-drying step weight.

The dried chips are then coated with a batter emulsion having the following composition:

| | |
|---|---|
| Water | 53.00%-60.00% |
| Sunflower Oil | 24.00%-28.00% |
| Starch (Hylon V11) | 10.00%-12.00% |
| Tumeric | 0.01%-0.10% |
| Liquid Paprika | 0.01%-0.10% |
| Hamultop 391 emulsifier | 0.80%-1.00% |
| H0w 1 stabiliser | 0.10%-0.30% |
| Salt | 4.00%-6.00% |

Coating of the chips is achieved using a batter enrober.

The coated chips are then dried at a temperature of around 120° C. During this second drying step the chips experience a drying loss of 12%.

After the second drying the step the coated chips are then partially cooked in an impingement oven at a temperature of between 250° C. to 285° C. During this impingement step the chips experience an impingement loss of between 24% and 27%.

The par-cooked chips are then frozen and packaged ready for supply to an end consumer.

The end consumer completes the cooking process by heating the chips from frozen for between 15 minutes and 18 minutes at a temperature of around 220° C.

### EXAMPLE 2

As in the example given above, the potatoes are peeled, trimmed and cut into a chip size. having a cross section of 11.2 mm by 11.2 mm ( 15/32 of an inch by 15/32 of an inch)

The chips are then blanched in water at a temperature of around 85° C. for 13 minutes.

After blanching the chips are dipped in an aqueous solution containing 1% Puron for 60 seconds at a temperature of around 65° C.

The dipped chips are then dried in an ambient temperature environment.

The dried chips are then enrobed with a batter emulsion having the following composition:

| | |
|---|---|
| Water | 48.00%-54.00% |
| Sunflower oil | 13.00%-16.00% |
| Modified Potato Starch E1412 | 9.00%-11.00% |
| Rice Flour | 5.00%-7.00% |
| Potato Dextrin | 9.00%-11.00% |
| Maize Starch | 4.00%-6.00% |
| Xantham Gum | 0.01%-0.10% |
| Sodium Bicarbonate | 0.30%-0.40% |
| Puron AG | 0.40%-0.50% |
| Salt | 1.00%-2.00% |
| Tumeric Extract Powder | 0.01%-0.10% |
| Paprika Oleoresin | 0.01%-0.10% |
| Vegetable Oil | 0.01%-0.10% |
| Dextrose | 0.30%-0.40% |
| Guar Gum | 0.01%-0.10% |

After the second drying the step the coated chips are then partially cooked in an impingement oven at a temperature of around 285° C. During this impingement step the chips experience an impingement loss of 21.8%

The par-cooked chips are then frozen and packaged ready for supply to an end consumer.

The end consumer completes the cooking process by heating the chips from frozen for 15 minutes at a temperature of around 220° C.

1. A method of preparing a potato based food product, the method comprising the steps of:
processing potatoes into potato articles having a desired size and shape,
blanching said potato articles,
dipping said blanched potato articles in a solution to prevent non-enzymic oxidation of the potato articles,
drying said potato articles,
coating said potato articles in an emulsion containing starch, oil, salt and colouring,
introducing said coated articles into a hot air environment; and
removing said articles from said hot air environment.

2. A method as claimed in claim 1 wherein the step of blanching the articles comprises immersing the potato articles in a heated water bath at a temperature of between 70° C. to 95° C. for between 5 minutes to 20 minutes.

3. A method as claimed in claim 1 or claim 2 wherein the step of dipping said blanched potato articles in a solution to prevent non-enzymic oxidation of the potato articles comprises immersing the articles in a Sodium Acid Pyrophosphate solution.

4. A method as claimed in claim 3 wherein the Sodium Acid Pyrophosphate solution comprises 1% Sodium Acid Pyrophosphate.

5. A method as claimed in claim 3 or claim 4 wherein the Sodium Acid Pyrophosphate solution is provided at a temperature of 65° C. and the articles are immersed for a time period of around 60 seconds.

6. A method as claimed in any preceding claim wherein the step of drying the blanched and dipped potato articles comprises introducing the articles into an elevated temperature environment.

7. A method as claimed in any of claims 1 to 5 wherein the blanched and dipped potato articles are dried at ambient temperature.

8. A method as claimed in any preceding claim wherein the emulsion comprises a mixture including water, oil, starch, colouring, emulsifier, stabilizer and salt.

9. A method as claimed in claim 8 wherein the emulsion comprises:

| | |
|---|---|
| Water | 53.00%-60.00% |
| Sunflower Oil | 24.00%-28.00% |
| Starch (Hylon V11) | 10.00%-12.00% |
| Tumeric | 0.01%-0.10% |
| Liquid Paprika | 0.01%-0.10% |
| Hamultop 391 emulsifier | 0.80%-1.00% |
| H0w 1 stabiliser | 0.10%-0.30% |
| Salt | 4.00%-6.00% |

10. A method as claimed in any of claims 1 to 8 wherein the emulsion comprises a mixture including water, oil, starch, flour, dextrin, gum, Sodium Bicarbonate, salt, colouring, oil, Sodium Acid Pyrophosphate and dextrose.

11. A method as claimed in claim 10 wherein the emulsion comprises:

| | |
|---|---|
| Water | 48.00%-54.00% |
| Sunflower oil | 13.00%-16.00% |
| Modified Potato Starch E1412 | 9.00%-11.00% |
| Rice Flour | 5.00%-7.00% |
| Potato Dextrin | 9.00%-11.00% |
| Maize Starch | 4.00%-6.00% |
| Xantham Gum | 0.01%-0.10% |
| Sodium Bicarbonate | 0.30%-0.40% |
| Puron AG | 0.40%-0.50% |
| Salt | 1.00%-2.00% |
| Tumeric Extract Powder | 0.01%-0.10% |
| Paprika Oleoresin | 0.01%-0.10% |
| Vegetable Oil | 0.01%-0.10% |
| Dextrose | 0.30%-0.40% |
| Guar Gum | 0.01%-0.10% |

12. A method as claimed in any preceding claim, the method may including the additional step of drying the potato articles after coating in the emulsion.

13. A method as claimed in claim 12 wherein the second drying step comprises introducing the coated articles into a warm air environment.

14. A method as claimed in claim 13 wherein the coated articles are dried at a temperature of between 100° C. and 130° C.

15. A method as claimed in claim 14 wherein the coated articles are dried at a temperature of between 105° C. and 120° C.

16. A method as claimed in any preceding claim wherein the final step of introducing the coated articles into a hot air environment comprises introducing the coated articles into an impingement oven.

17. A method as claimed in claim 16 wherein the hot air environment has a temperature of between 240° C. to 285° C.

18. A coating for a potato article, the coating comprising an emulsion containing oil, starch, salt and colouring.

19. A coating as claimed in claim 18 wherein the emulsion comprises a mixture including water, oil, starch, colouring, emulsifier, stabilizer and salt.

20. A coating as claimed in claim 19, the emulsion comprising:

| | |
|---|---|
| Water | 53.00%-60.00% |
| Sunflower Oil | 24.00%-28.00% |
| Starch (Hylon V11) | 10.00%-12.00% |
| Tumeric | 0.01%-0.10% |
| Liquid Paprika | 0.01%-0.10% |
| Hamultop 391 emulsifier | 0.80%-1.00% |
| H0w 1 stabiliser | 0.10%-0.30% |
| Salt | 4.00%-6.00% |

21. A coating as claimed in claim 18 wherein the emulsion may comprise a mixture including water, oil, starch, flour, dextrin, gum, Sodium Bicarbonate, salt, colouring, oil, Sodium Acid Pyrophosphate and dextrose.

22. A coating as claimed in claim 21, the emulsion comprising:

| | |
|---|---|
| Water | 48.00%-54.00% |
| Sunflower oil | 13.00%-16.00% |
| Modified Potato Starch E1412 | 9.00%-11.00% |
| Rice Flour | 5.00%-7.00% |
| Potato Dextrin | 9.00%-11.00% |
| Maize Starch | 4.00%-6.00% |
| Xantham Gum | 0.01%-0.10% |
| Sodium Bicarbonate | 0.30%-0.40% |
| Puron AG | 0.40%-0.50% |
| Salt | 1.00%-2.00% |
| Tumeric Extract Powder | 0.01%-0.10% |
| Paprika Oleoresin | 0.01%-0.10% |
| Vegetable Oil | 0.01%-0.10% |
| Dextrose | 0.30%-0.40% |
| Guar Gum | 0.01%-0.10% |
